(19) United States
(12) Patent Application Publication
(10) Pub. No.: US 2026/0352244 A1
(43) Pub. Date: Nov. 5, 2026

(54) BROADBAND REINFORCEMENT LEARNING RECEIVER WITH IMPROVED SENSITIVITY, SIGNAL-TO-NOISE RATIO, AND DYNAMIC RANGE

(71) Applicant: Qorvo US, Inc., Greensboro, NC (US)

(72) Inventors: Kevin Kobayashi, Redondo, CA (US); Paul Gorday, Palm Beach, FL (US); Charles Campbell, Dallas, TX (US); Gangadhar Burra, Fremont, CA (US)

(21) Appl. No.: 19/561,858

(22) Filed: Mar. 10, 2026

Related U.S. Application Data
(60) Provisional application No. 63/797,526, filed on Apr. 30, 2025.

(51) Int. Cl. H04B 1/10

(52) U.S. Cl. CPC H04B 1/10

(57) ABSTRACT

A radio frequency (RF) receiver includes a signal path, which includes an antenna, a low noise amplifier (LNA) operatively coupled to the antenna, and a variable gain amplifier/attenuator operatively coupled to the LNA. The receiver also includes an intrinsically switched multiplexer (ISM), and a bypass switch network operatively coupled to the ISM and selectively operable between a first state and a second state, where in the first state the ISM is switched into the signal path between the antenna and the LNA, and in the second state the ISM is bypassed out of the signal path. The receiver also includes a switch driver configured to set the bypass switch network into the first state based on a first detection and to set the bypass switch network into the second state based on a second detection.

### CROSS REFERENCE TO RELATED APPLICATIONS

This application claims the priority benefit under 35 U.S.C. § 119 (e) of U.S. Provisional Patent Application No. 63/797,526 filed 30 Apr. 2025, hereby incorporated by reference in its entirety as though fully set forth herein.

### TECHNICAL FIELD

The subject matter described herein relates to devices, systems, and methods for selectively bypassing an intrinsically switched multiplexer (ISM) or frequency select limiter (FSL). This bypassable multiplexed ISM has particular but not exclusive utility for radio frequency (RF) satellite communication.

### BACKGROUND

High receiver sensitivity and low receiver noise function (NF) improves the wireless reach of a communication system. In an extreme case, the communication link may need to reach a satellite in geosynchronous or medium earth orbit. In yet another case, the link may be interplanetary, such as an interplanetary communication link to Mars. High receiver sensitivity and low NF may also improve the latency of a global positioning system (GPS) satellite system in which a higher-sensitivity receiver may reduce the latency involved in acquiring and demodulating information from a spread spectrum signal. In some cases, the need for receiver low noise figure and high sensitivity may be invaluable to system applications which require a quick response.

An intrinsically switched multiplexing filter (ISM) has a plurality of filters coupled between an antenna and receiver ports. Each filter has its respective frequency passbands. The ISM has digital control inputs that allow individual passbands of the ISM to be switched on or off, thereby selectively attenuating strong signals at specific frequencies. Given its relatively low insertion loss, flat passband, and steep transition bands, an ISM can be used to limit the power of strong signals. For example, an ISM can be used prior to a low noise amplifier (LNA) in the receiver front-end to attenuate strong signals at the input of the LNA. However, the ISM can introduce losses on the order of 4-6 dB, which may be significant when trying to interpret weak signals.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a bypassable multiplexed ISM, which can mitigate the signal losses associated with the ISM when the input signal is weaker than a threshold power level, by bypassing the ISM in the signal path. The bypassable multiplexed ISM disclosed herein has particular, but not exclusive, utility for RF satellite communications.

One general aspect includes a radio frequency (RF) receiver that includes a signal path which may include: an antenna, a low noise amplifier (LNA) operatively coupled to the antenna, and a variable gain amplifier/attenuator operatively coupled to the LNA. The receiver also includes an intrinsically switched multiplexer (ISM), and a bypass switch network operatively coupled to the ISM and selectively operable between a first state and a second state, where in the first state the ISM is switched into the signal path between the antenna and the LNA, and where in the second state the ISM is bypassed out of the signal path. The receiver also includes a switch driver configured to set the bypass switch network into the first state based on a first detection and to set the bypass switch network into the second state based on a second detection.

Implementations may include one or more of the following features. In some embodiments, the bypass switch network may include a first RF bypass switch that, in the second state, couples the antenna to the LNA and, in the first state, couples the antenna to the ISM. In some embodiments, the bypass switch network further may include a second RF bypass switch that, in the second state, uncouples the ISM from the LNA and, in the first state, couples the ISM to the LNA. In some embodiments, the second detection may include a power level at an input of the ISM or a power level at an output of the ISM. In some embodiments, the first detection may include a distortion level detected by the distortion detector. In some embodiments, the RF receiver may include a reinforcement learning model or lookup table that receives inputs from the distortion detector and a power detector or power spectrum detector of the ISM, and generates outputs to perform at least one of: actuating the bypass switch network; changing a bias of the LNA; changing an amplification or attenuation of the variable gain amplifier/attenuator; or configuring attenuation states of the ISM. In some embodiments, the first detection may include a change in the bias of the LNA generated by the reinforcement learning model or lookup table.

One general aspect includes a method for using an RF receiver with a signal path that may include: an antenna, a low noise amplifier (LNA) operatively coupled to the antenna, and a variable gain amplifier/attenuator operatively coupled to the LNA, an intrinsically switched multiplexer (ISM). The receiver also includes a bypass switch network operatively coupled to the ISM and selectively operable between a first state and a second state, where in the first state the ISM is switched into the signal path between the antenna and the LNA, and where in the second state the ISM is bypassed out of the signal path. The receiver also includes a switch driver configured to select between the first state and the second state, where the method may include: with the switch driver: setting the bypass switch network into the first state based on a first detection, and setting the bypass switch network into the second state based on a second detection.

Implementations may include one or more of the following features. In some embodiments, the bypass switch network may include a first RF bypass switch that, in the second state, couples the antenna to the LNA and, in the first state, couples the antenna to the ISM. In some embodiments, the bypass switch network further may include second RF bypass switch that, in the second state, uncouples the ISM from the LNA and, in the first state, couples the ISM to the LNA. In some embodiments, the second detection may include a power level at an input of the ISM or a power level at an output of the ISM. In some embodiments, the first detection may include a distortion level detected by the distortion detector. In some embodiments, the method may include, with a reinforcement learning model or lookup table: receiving inputs from the distortion detector and a power detector or power spectrum detector of the ISM; and generating outputs to perform at least one of: actuating the bypass switch network; changing a bias of the LNA; changing an amplification or attenuation of the variable gain amplifier/attenuator; or configuring attenuation states of the ISM. In some embodiments, the first detection may include a change in the bias of the LNA generated by the reinforcement learning model or lookup table.

One general aspect includes a wireless device comprising an RF receiver with a signal path that may include: an antenna, a low noise amplifier (LNA) operatively coupled to the antenna, and a variable gain amplifier/attenuator operatively coupled to the LNA. The device also includes an intrinsically switched multiplexer (ISM); a bypass switch network operatively coupled to the ISM and selectively operable between a first state and a second state, where in the first state the ISM is switched into the signal path between the antenna and the LNA, and where in the second state the ISM is bypassed out of the signal path; and a switch driver configured to set the bypass switch network into the first state based on a first detection and to set the bypass switch network into the second state based on a second detection.

Implementations may include one or more of the following features. In some embodiments, the bypass switch network may include a first RF bypass switch that, in the second state, couples the antenna to the LNA and, in the first state, couples the antenna to the ISM. In some embodiments, the bypass switch network further may include second RF bypass switch that, in the second state, uncouples the ISM from the LNA and, in the first state, couples the ISM to the LNA. In some embodiments, the second detection may include a power level at an input of the ISM or a power level at an output of the ISM. In some embodiments, the first detection may include a distortion level detected by the distortion detector. In some embodiments, the wireless device may include a reinforcement learning model or lookup table that receives inputs from the distortion detector and a power detector or power spectrum detector of the ISM, and generates outputs to perform at least one of: actuating the bypass switch network; changing a bias of the LNA; changing an amplification or attenuation of the variable gain amplifier/attenuator; or configuring attenuation states of the ISM.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the bypassable multiplexed ISM, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation of satellite orbits around the Earth, in accordance with at least one embodiment of the present disclosure.

FIG. 2 is a schematic, diagrammatic representation, in block diagram form, of an existing reinforcement learning receiver (RL-RX), in accordance with at least one embodiment of the present disclosure.

FIG. 3A is a schematic, diagrammatic representation, in block diagram form, of a novel reinforcement learning receiver (RL-RX), in accordance with at least one embodiment of the present disclosure.

FIG. 3B is a schematic, diagrammatic representation, in block diagram form, of a novel reinforcement learning receiver (RL-RX), in accordance with at least one embodiment of the present disclosure.

FIG. 4 is a schematic, diagrammatic representation, in block diagram form, of a novel reinforcement learning receiver (RL-RX), in accordance with at least one embodiment of the present disclosure.

FIG. 5A is a schematic, diagrammatic representation, in block diagram form, of a novel reinforcement learning receiver (RL-RX), in accordance with at least one embodiment of the present disclosure.

FIG. 5B is a schematic, diagrammatic representation, in block diagram form, of a novel reinforcement learning receiver (RL-RX), in accordance with at least one embodiment of the present disclosure.

FIG. 6 is a graphical representation of signal power vs. frequency, in accordance with at least one embodiment of the present disclosure.

FIG. 7 is a graphical representation of signal power vs. frequency, in accordance with at least one embodiment of the present disclosure.

FIG. 8 is a graphical representation of signal power vs. frequency, in accordance with at least one embodiment of the present disclosure.

FIG. 9 is a schematic, diagrammatic representation, in flow diagram form of an example multiplexed ISM bypassing method, in accordance with at least one embodiment of the present disclosure.

### DETAILED DESCRIPTION

In accordance with at least one embodiment of the present disclosure, a bypassable multiplexed ISM is provided which can mitigate the signal losses associated with the ISM when the input signal is weaker than a threshold power level, by bypassing the ISM or frequency select limiter (FSL) in the signal path.

The present disclosure includes a wideband reinforcement learning receiver, and achieves an improvement in noise figure (NF) sensitivity by 4-6 dB, as well as an improvement in signal to noise and distortion ratio (SNDR or SNaDR) by 10-12 dB. This is accomplished by employing a bypass switch network about an ISM/FSL as well as a variable gain amplifier (VGA)-attenuator positioned after the low-noise amplifier (LNA), and an RF reinforcement learning (RL) algorithm for controlling and optimizing the wideband RL receiver architecture.

Key to achieving the improvements in sensitivity and NF is the use of a bypass switch about the ISM/FSL to reduce front end loss under low detected RF input power. SNDR is further improved by adjusting and optimizing the power level delivered from the output of the high dynamic range gallium nitride low-noise amplifier (HDR GaN LNA) to the successive transceiver-section, linear driver amp, and analog-to-digital converter (ADC) sections in order to maintain optimal linear operation and performance.

The reinforcement learning adaptive-reconfigurable receiver includes an intrinsically switched multiplexer (ISM) or frequency select limiter (FSL) for attenuating large un-desired RF frequency band(s) and for sensing RF frequency band power, a bypass pass switch network about the ISM (FSL) controlled by an RL agent (or may alternatively be autonomous), a bias and wide dynamic range reconfigurable broadband LNA that detects baseband distortion byproducts, as well as provides an amplified RF spectrum that may be analyzed through a digital signal processing (DSP) microprocessor unit or field programmable neural array (FPNA), an RL algorithm that considers multiple inputs (ISM-FSL power level and frequency, LNA baseband byproduct distortion, LNA direct current (DC) dynamic gate(s) and drain bias currents, LNA RF amplified spectrum analyzed through a DSP unit) in determining optimal bias and frequency reconfigurable LNA settings, FSL settings, power dependent switched bypassing setting(s) (for improved sensitivity and SNR under low received power levels), and appropriate post-LNA VGA/attenuator settings, to achieve improved overall system receiver performance (efficiency, linearity, noise, SNR, bandwidth, efficiency) under a changing RF spectral environment.

At a low received power of −30 dBm, the disclosed RL-assisted architecture may operate in high sensitivity bypass mode which improves the receiver NF and sensitivity by as much as 6 dB, with a corresponding 12 dB improvement in SNR versus the ISM operating mode.

Conversely, at a high received power level of 15 dBm, the RL-assisted architecture may operate in in ISM mode which selectively levels the LNA input received power level to less than a threshold power (Pth, e.g., ~−20 dBm), protecting and enhancing the LNA operation and performance and, in conjunction with a post-LNA VGA/attenuator, enhancing the overall SNDR receiver performance by as much as 21 dB for a GaN LNA implementation and as much as 30 dB for a less linear GaAs LNA implementation.

Thus, the bypassable multiplexed ISM enables a wideband reinforcement learning system with improved sensitivity, NF, SNR, SNDR, and dynamic range. Key features of the RL-based receiver (RL-RX) include:
RL optimizes and adapts RF performance to changing environments (e.g., broadband linear efficiency, DR, SNR, latency, interference mitigation)
Relies on baseband detection of RF in-band distortion byproduct for low latency, as described for example in U.S. Publication No. 2022/0255512, filed 29 Jul. 2020, entitled “Reconfigurable Amplifier”, which is incorporated by reference as though fully set forth herein.
Exploits advanced HDR GaN (or scandium aluminum nitride (ScAIN)) device technology and baseband to millimeter wave low noise-high third order intercept point (IP3) distributed amplifier, as described for example in U.S. Pat. No. 8,665,022, filed 27 Apr. 2012, entitled “Low Noise Linear Power Distributed Amplifier”, which is incorporated by reference as though fully set forth herein.
Leverages RL assisted N-plexed ISM for high spurious free dynamic range (SFDR), as described for example in U.S. Provisional Patent No. 63/660,385, filed 14 Jun. 2024, entitled “System and Methods for Controlling Filter Bank Device”, and U.S. Pat. No. 11,245,427, filed 11 Feb. 2021, entitled “Frequency Selective Limiter”, each of which is incorporated by reference as though fully set forth herein.
Improves on prior RL-RX work as described for example in U.S. Publication No. 2024/0048166, filed 17 Jul. 2023, entitled “Reinforcement Learning Receiver Front-End”, which is incorporated by reference as though fully set forth herein.
RL framework is applicable to other RF front-end applications.

The present disclosure builds on this work by improving the RL-RX system. One problem with existing systems is that the use of an FSL (ISM) introduces ~4-6 dB loss, thus reducing RX sensitivity, SNR, and system link reach. The solution disclosed herein is to incorporate ISM RF bypass switches to improve receive (RX) sensitivity by 5-6 dB and SNR by ~10-12 dB under low power conditions.

In one preferred embodiment, the RF bypass switches may be actuated (e.g., switched to ON or bypass mode) when the detected input power is below a given input power threshold (e.g., Pth<−20 dBm) that may be detected by the ISM input power detector, inferred from LNA baseband byproduct distortion detector, or other external detector, resulting in a reduction of loss to improve NF and sensitivity by 5-6 dB and SNDR by 10-12 dB. Above a given detected power level, or in the presence of detected distortion, the RF bypass switches may be actuated OFF, employing the ISM which improves the SFDR in the presence of larger received RF spectrum.

In another embodiment, an additional 1 dB of sensitivity and 2 dB SNR improvement may be obtained by employing only one bypass switch in the RF LNA path while configuring an isolation switch coupled at the output of the ISM to improve isolation between the ISM output and the LNA input.

Detected power level may be obtained from the ISM or an external detector, and may operate autonomously or using ML/RL assistance. Detected distortion byproduct level may be obtained from the LNA and baseband distortion detector to facilitate autonomous actuation of the bypass and/or isolation switch when enabling the ISM mode of operation.

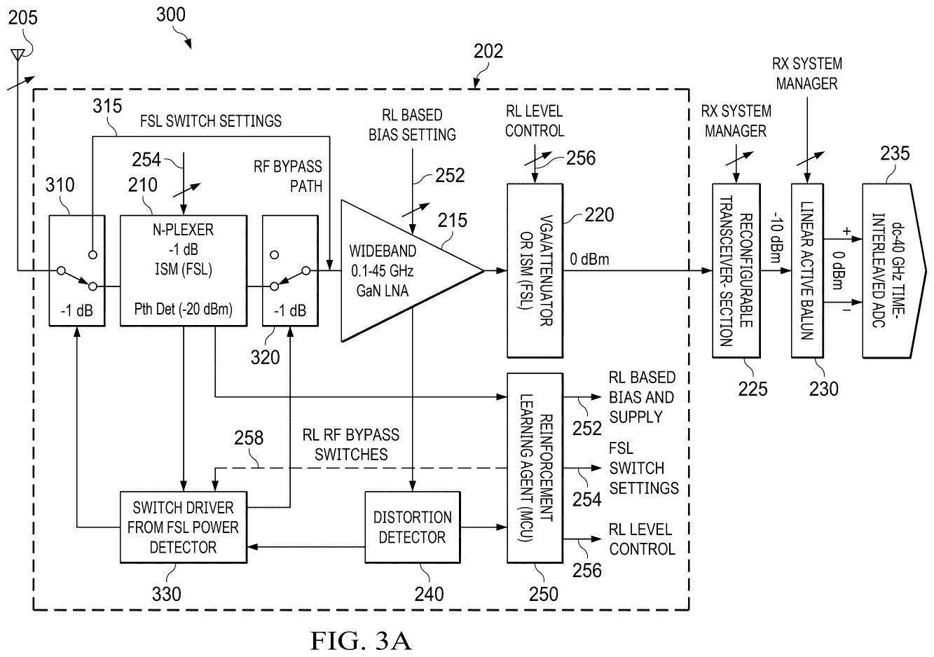

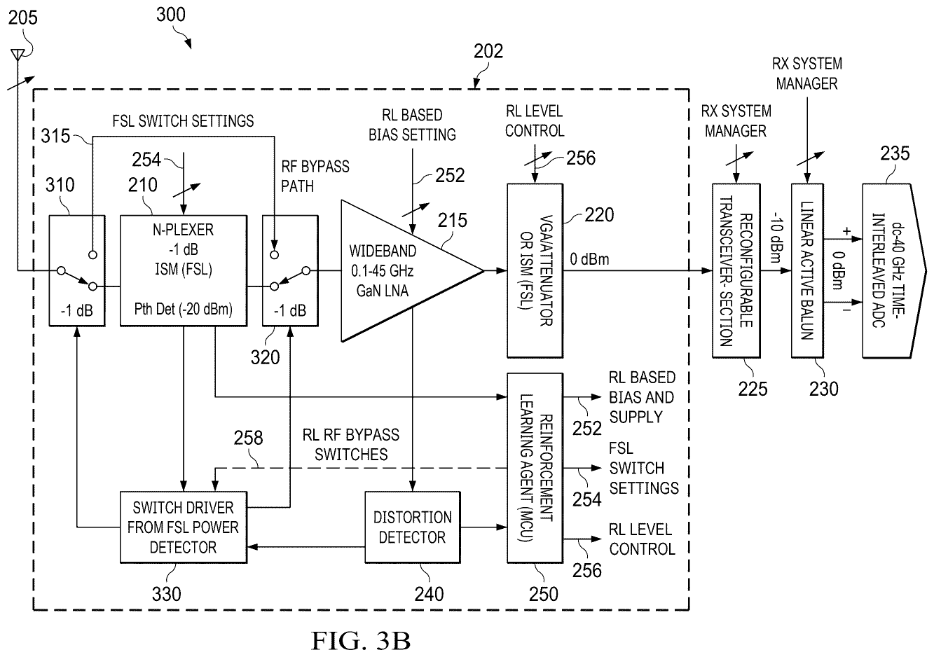

The present disclosure aids substantially in long-range RF communication, by improving both sensitivity and signal-to-noise and distortion ratio (SNDR). Implemented on a reinforcement learning RF receiver that employs a multiplexed ISM or FSL, the bypassable multiplexed ISM disclosed herein provides practical, measurable improvement in the receiver. This improved receiver transforms a weak signal into one that is 4-5 dB stronger than previous RL-RX designs, without the normally routine need to increase amplification (and thus also increase distortion). This unconventional approach improves the functioning of the RL-RX receiver, by bypassing the ISM when the received signal power falls below a threshold value. The improvement is between the two different modes based on FIG. 3A, which shows the ISM path will incur losses of 1+1+4+1=7 dB, while the LNA path shows a loss of only 1 dB. However, with respect to an architecture having no switches and no ISM, the loss is 1+4−1=4 dB if the following are neglected: a) nplexer loss of 1 dB being optimistic over the band and b) cascaded link analysis where successive stages of noise contribution is affected by prior stage gain (cascaded NF formula).

These descriptions are provided for exemplary purposes only, and should not be considered to limit the scope of the bypassable multiplexed ISM. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

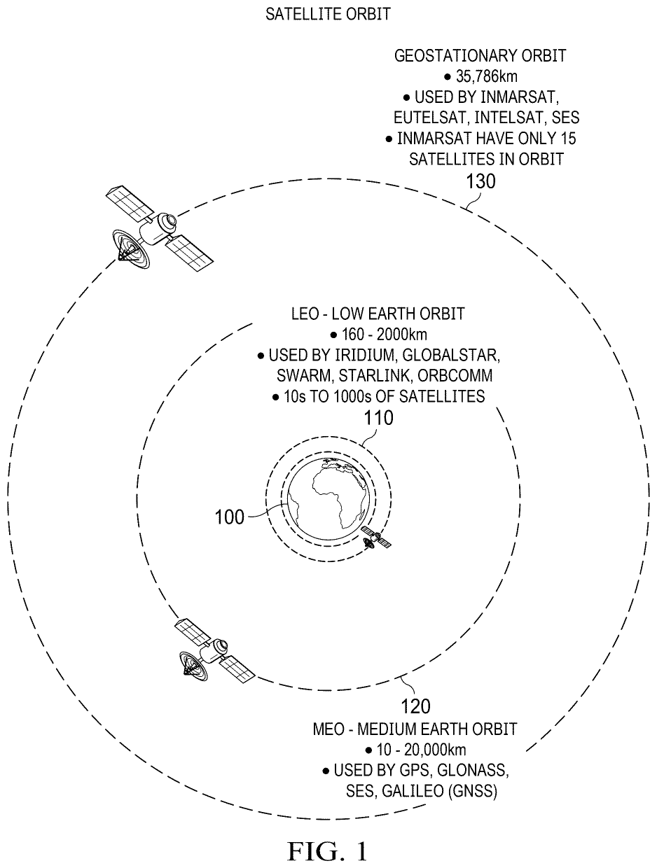

FIG. 1 is a schematic, diagrammatic representation of satellite orbits around the Earth 100, in accordance with at least one embodiment of the present disclosure. Visible are a low Earth orbit (LEO) 110, a medium Earth orbit (MEO) 120, and a geostationary or geosynchronous orbit (GEO) 130. LEO 110 extends from roughly 160 km to roughly 2000 km above the Earth's surface, and contains satellite constellations comprising tens to thousands of satellites, including for example Iridium, Globalstar, Swarm, Starlink, and Orbcomm. MEO 120 extends from roughly 10,000 to 20,000 km above the Earth's surface, and is used for example by satellite constellations including GPS, GLONASS, SES, and Galileo or GNSS. GEO 130 occurs at an altitude of 35,786 km above the Earth's surface, and is used for example by communication satellite constellations such as Inmarsat, Eutelsat, Intelsat, and SES. RF requirements for communication between Earth's surface and various satellite orbits are shown below in Table 1.

TABLE 1
Satellite Communications Requirements

| | Typical | Typical | |
|---|---|---|---|
| Satellite System | Sensitivity (dBm) | SNR (dB) | Reach (km) |
| LEO | −130 | 10-25 | 160-2,000 |
| LEO - Starlink | −110 to −120 | >10 | 160-2,000 |
| MEO | | | 10K-20K |
| GEO - Comm | −120 to −130 | 20-30 | 36K |
| GEO - GNSS | −150 to −165 | Min 30-35 | 36K |

Before continuing, it should be noted that the examples described above are provided for purposes of illustration, and are not intended to be limiting.

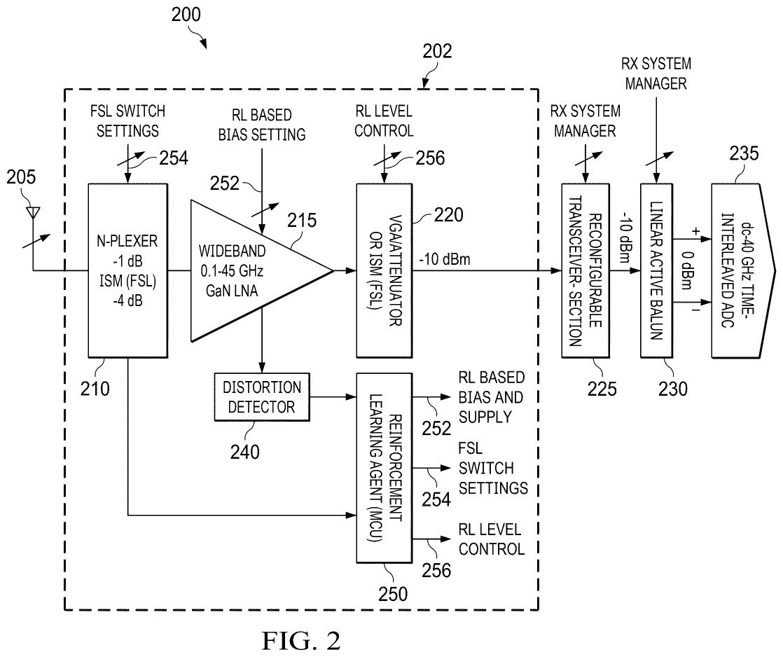

FIG. 2 is a schematic, diagrammatic representation, in block diagram form, of an existing reinforcement learning receiver (RL-RX) 200, in accordance with at least one embodiment of the present disclosure. The RL-RX 200 includes an antenna 205, feeding into an N-plexed ISM/FSL 210, which feeds into a wideband (0.1-1.45 GHZ) GaN LNA 215, which feeds into a variable gain amplifier/attenuator 220 (which may for example be implemented as another ISM/FSL), which feeds into a reconfigurable transceiver section 225, which feeds into a linear active balun or linear driver amplifier 230, which feeds into an analog-to-digital converter 235 (e.g., a time-interleaved ADC). The GaN LNA 215 is monitored by a distortion detector 240. Both the distortion detector 240 and the N-plexed ISM/FSL 210 provide inputs to a reinforcement learning agent microcontroller unit (MCU) 250, which provides, as outputs, an RL-based bias and supply voltage 252, FSL switch settings 254, and RL level control 256.

This figure illustrates a block diagram of a baseline reinforcement learning receiver from antenna 205 to the digital domain (RF to bits). The block 202 pertains to an existing broadband RL receiver that integrates an N-plexed ISM (FSL bank) 210, wide dynamic range GaN LNA 215, baseband distortion detector 240, and an RL agent 250 to control the ISM and LNA. An additional VGA/attenuator 220 may, in some embodiments, be implemented or as an ISM. The VGA/attenuator 220 is capable of applying a gain either greater than 1 (amplification) or less than 1 (attenuation). This block is followed by a reconfigurable transceiver section 225, a linear differential active balun or linear differential driver 230, and an ADC 235. It is noted that a balun 230 may have only one input whereas a linear differential driver 230 may have two inputs. Key link loss and power levels are given in the diagram and well as example technologies.

A link budget analysis was performed with respect to the existing wideband RL receiver, (RL-RX), and shows a loss of approximately −1 dB at the N-plexer and −4 dB at the ISM or FSL (e.g., when the N-plexer is not power-limiting an input signal), as well as −10 dBm between the VGA/attenuator 220 and the reconfigurable transceiver section 225, and −10 dBm between the reconfigurable transceiver section 225 and the balun 230. It is an object of the present disclosure to mitigate the ~5 dB of losses associated with the N-plexed ISM/FSL 210. It is noted that in some embodiments, the N-plexed ISM/FSL 210 may be a tree of filters, e.g., the N-plexer may include multiple ISMs, each of which may include multiple FSLs. However, in other cases a simpler structure may be used, including for example a single ISM or FSL.

A reconfigurable low noise amplifier (LNA) of FIG. 2 may be similar to those described in U.S. Publication No. 2022/0255512, filed 29 Jul. 2020, entitled “Reconfigurable Amplifier”. A low noise-linear distributed amplifier may of FIG. 2 be similar to those described in U.S. Pat. No. 8,665,022, filed 27 Apr. 2012, entitled “Low Noise Linear Power Distributed Amplifier”. A reinforcement learning assisted, N-plexed intrinsically switched multiplexer (ISM) for high spurious free dynamic range (SFDR), as shown in FIG. 2, may be similar to those described in U.S. Provisional Patent No. 63/660,385, filed 14 Jun. 2024, entitled “System and Methods for Controlling Filter Bank Device”. A frequency selective limiter (FSL) of FIG. 2 may be similar to those described in U.S. Pat. No. 11,245,427, filed 11 Feb. 2021, entitled “Frequency Selective Limiter”. A reinforcement learning based receiver of FIG. 2 may be similar to those described in U.S. Publication No. 2024/0048166, filed 17 Jul. 2023, entitled “Reinforcement Learning Receiver Front-End”. Each of these is incorporated by reference as though fully set forth herein.

Block diagrams are provided herein for exemplary purposes; a person of ordinary skill in the art will recognize myriad variations that nonetheless fall within the scope of the present disclosure. For example, block diagrams may show a particular arrangement of components, modules, services, steps, processes, or layers, resulting in a particular flow of data, power, energy, or signal. It is understood that some embodiments of the systems disclosed herein may include additional components, that some components shown may be absent from some embodiments, and that the arrangement of components may be different than shown, resulting in different data, power, energy, or signal flows while still performing the methods described herein.

FIG. 3A is a schematic, diagrammatic representation, in block diagram form, of a novel reinforcement learning receiver (RL-RX) 300, in accordance with at least one embodiment of the present disclosure. Visible are the antenna 205, N-plexed ISM/FSL 210, LNA 215, variable gain amplifier/attenuator 220, reconfigurable transceiver section 225, balun 230, analog-to-digital converter 235, distortion detector 240, reinforcement learning agent 250, RL-based bias and supply voltage 252, FSL switch settings 254, and RL level control 256, and optionally RL RF bypass switch actuation control signal 258.

However, the RL-RX 300 also includes a bypass switch 310 and an isolation switch 320 which can enable an RF bypass path 315 that bypasses the N-plexed ISM/FSL 210. The isolation switch 320 tracks the bypass switch 310 to prevent loading down the LNA input by the Nplexed ISM. This switch port may be an open or some intentional impedance which benefits overall operation and performance. In this diagram the switch is not in bypass mode. Rather, in the example shown in FIG. 3, these switches 310 and 320 are in the OFF (e.g., not bypassed) position. The RL-RX 300 also includes a switch driver 330 that receives an input power measurement from the N-plexed ISM/FSL 210, as well as a distortion detection or distortion measurement from the distortion detector 240. When the received signal's power level is less than the detection threshold Pth, the switch driver 330 will flip the switches into the ON (e.g., bypassed) position. However, when the switches are in the ON position, the N-plexed ISM/FSL no longer receives power, and thus the switch driver 330 cannot flip the switches back into the OFF position when the input power exceeds Pth. Rather, the switches are flipped back into the OFF (e.g., not bypassed) position when the distortion detector 240 detects signal distortion coming out of the LNA 215, which is an indication of high input signal power.

When the ISM is filtering the input signal due to high input signal power, it introduces a loss of, for example, −20 dB, in addition to a −1 dB loss from the N-plexer and a −1 dB loss from each of the switches 310 and 320. However, in the ON (e.g., bypassed) state, the losses from the N-plexed ISM/FSL 210 are bypassed, so that the only losses within the block 202 are the −1 dB losses from the switches themselves.

Thus, the bypass switches 310 and 320 are used to extend the sensitivity, NF, SNR, and dynamic range of the receiver at lower input signal power. FIG. 3 illustrates the use of the N-plexed ISM/FSL 210 as a power detector, although it is understood that a separate power detector may be used instead or in addition. When the input power Pin is less than the threshold power Pth (e.g., ~−20 dBm), the switches are actuated through a switch driver that receives the ISM-detected power indicator and switches both switches 310, 320 to the RF bypass path 315. When excessive power is detected from the LNA baseband distortion detector 240, possibly in conjunction with other monitors such as LNA dynamic bias, etc., the bypass switches are switched to the ISM RF path while the ISM all-pass condition setting is re-initialized and the ISM operation is invoked again. Based on spectral information gathered from the N-plexed ISM/FSL 210, LNA baseband distortion byproduct spectrum, and optionally other system monitors such as in-line power couplers, the VGA/attenuator 220 will adjust and level the power feeding to the next section (e.g., the transceiver-section 225) in order to optimize overall system SNaDR. In some embodiments, the function of the VGA/attenuator 220 may be implemented by a broadband ISM for selectively leveling down large RF signals in specific frequency bands, while allowing unattenuated signals in a desired band, in conjunction with the overall system operation for optimizing overall system performance.

In some embodiments, the switch driver may (instead of or in addition to being controlled by the power detector of the N-plexed ISM/FSL 210 and/or the distortion detector 240) be controlled by, or receive inputs from, the reinforcement learning (RL) agent 250. The RL Agent 250 may determine when to actuate the bypass switch(es) based on detected inputs from the Nplexer 210 and LNA baseband distortion detector 240 for optimizing performance and receiver operation. Alternatively, direct spectral power detection from the ISM and distortion detection from the LNA distortion detector can be used to reduce latency of actuating the RF bypass switches.

FIG. 3B is a schematic, diagrammatic representation, in block diagram form, of a novel reinforcement learning receiver (RL-RX) 300, in accordance with at least one embodiment of the present disclosure. FIG. 3B is identical to FIG. 3A except that the switch 320 has been configured as a second bypass switch rather than as an isolation switch.

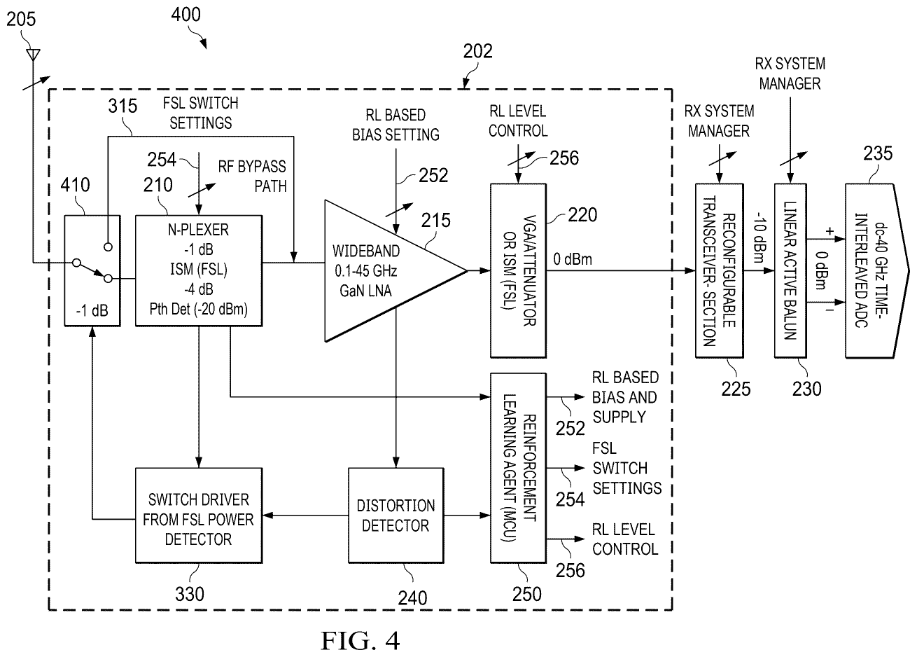

FIG. 4 is a schematic, diagrammatic representation, in block diagram form, of a novel reinforcement learning receiver (RL-RX) 400, in accordance with at least one embodiment of the present disclosure. Visible are the antenna 205, N-plexed ISM/FSL 210, LNA 215, variable gain amplifier/attenuator 220, reconfigurable transceiver section 225, balun 230, analog-to-digital converter 235, distortion detector 240, reinforcement learning agent 250, RL-based bias and supply voltage 252, FSL switch settings 254, and RL level control 256.

However, the RL-RX 400 also includes only a single bypass switch 410 operated by the switch driver 330, to improve the NF by ~1 dB (switch loss) and SNR by 2 dB during low power (Pin<Pth) bypass operation with respect to the configuration shown in FIG. 3B. In some embodiments, in order to maintain isolation between the ISM and LNA in the ON/bypass mode, the N-plexed ISM/FSL 210 may be switched to an ALL-attenuation state so as not to load down the input of the LNA 215.

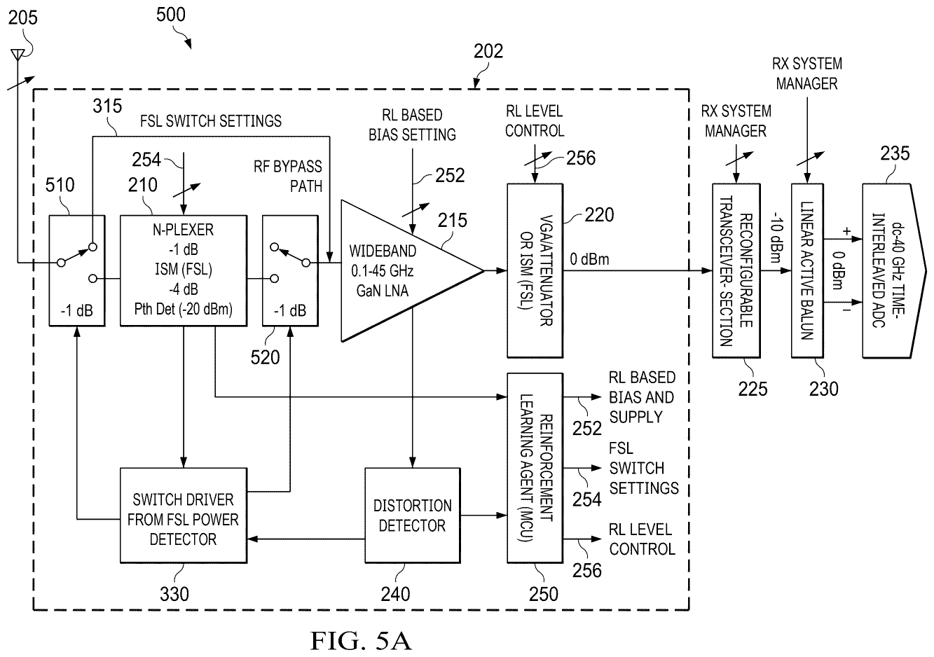

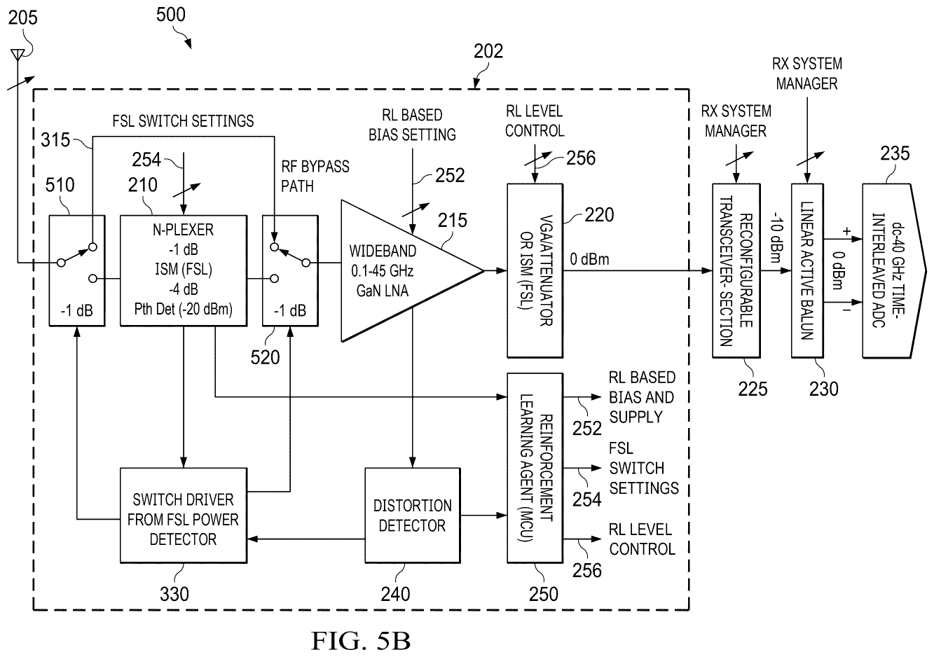

FIG. 5A is a schematic, diagrammatic representation, in block diagram form, of a novel reinforcement learning receiver (RL-RX) 500, in accordance with at least one embodiment of the present disclosure. Visible are the antenna 205, N-plexed ISM/FSL 210, LNA 215, variable gain amplifier/attenuator 220, reconfigurable transceiver section 225, balun 230, analog-to-digital converter 235, distortion detector 240, reinforcement learning agent 250, RL-based bias and supply voltage 252, FSL switch settings 254, and RL level control 256.

Similar to the RL-RX 300 of FIG. 3, the RL-RX 500 of FIG. 5 also includes two bypass switches 510 and 520. However, the second bypass switch 520 is located within the N-plexed ISM/FSL path rather than within the bypass path 315, and is thus used only to isolate the N-plexed ISM/FSL 210 from the LNA 215 in the ON/bypassed state. Thus, only one bypass switch 510 is used in the RF bypass path 315, to improve the NF by ~1 dB (switch loss) and SNR by 2 dB during low power (Pin<Pth) bypass operation with respect to the configuration shown in FIG. 3B. In order to further enhance the isolation between the ISM and LNA in bypass mode, the isolation switch 520 is cascaded right at the output of the N-plexed ISM/FSL 210 (not in the RF bypass path 315 as in FIG. 3), and may be switched so as not to load down the input of the LNA 215 (RF bypass path). In some embodiments, this may be done in conjunction with setting the ISM to an ALL-attenuation state to minimize coupled loading of the LNA 215 and RF bypass path 315. Thus, while the first bypass switch 510 is ON (e.g., connecting the LNA 215 to the antenna 205), the second bypass switch 520 is OFF or switched to the open terminal (e.g., disconnecting the LNA 215 from the N-plexed ISM/FSL 210).

FIG. 5B is a schematic, diagrammatic representation, in block diagram form, of a novel reinforcement learning receiver (RL-RX) 500, in accordance with at least one embodiment of the present disclosure. FIG. 5B is identical to FIG. 5A except that the switch 320 has been configured as a second bypass switch rather than as an isolation switch.

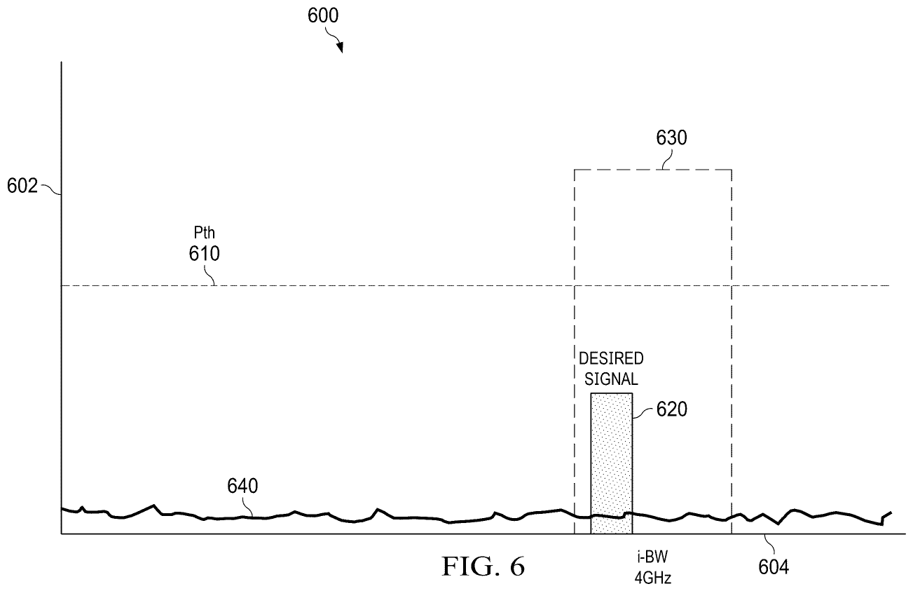

FIG. 6 is a graphical representation 600 of signal power 602 vs. frequency 604, in accordance with at least one embodiment of the present disclosure. In a first scenario, a desired signal 620 within a detection/filtering band 630 has a received power 602 that is less than the threshold power Pth 610, in the context of a wideband RF receiver (e.g. DC-40 GHz) front-end section that must perform interference mitigation. The first scenario is the high sensitivity scenario in which all power levels detected at the front end of the receiver is lower than Pth. The Pth may for example be determined by what the following LNA may be able to handle in terms of input with respect to its SNDR, linearity, pulsed recovery, and/or survivability. This Pth may be ~−20 dBm for a typical communication system, but can vary in a functionally dynamic system.

When the detected input power per ISM band is below this Pth 610, the bypass switch(es) and optional isolation switch are switched for RF bypass mode operation (e.g., bypass switch(es) ON), thus bypassing the lossy ISM and improving the loss by the loss difference between the ISM and the one or two switches. This will improve the sensitivity and NF of the receiver by ~4-6 dB and the SNR by ~8-12 dB, which can significantly extend the reach (distance) of a communication link for a multi-functional dynamic radio.

Line 640 shows noise plus distortion, which is primarily noise in the examine shown in FIG. 6, because there are no strong signals that cause distortion in the LNA.

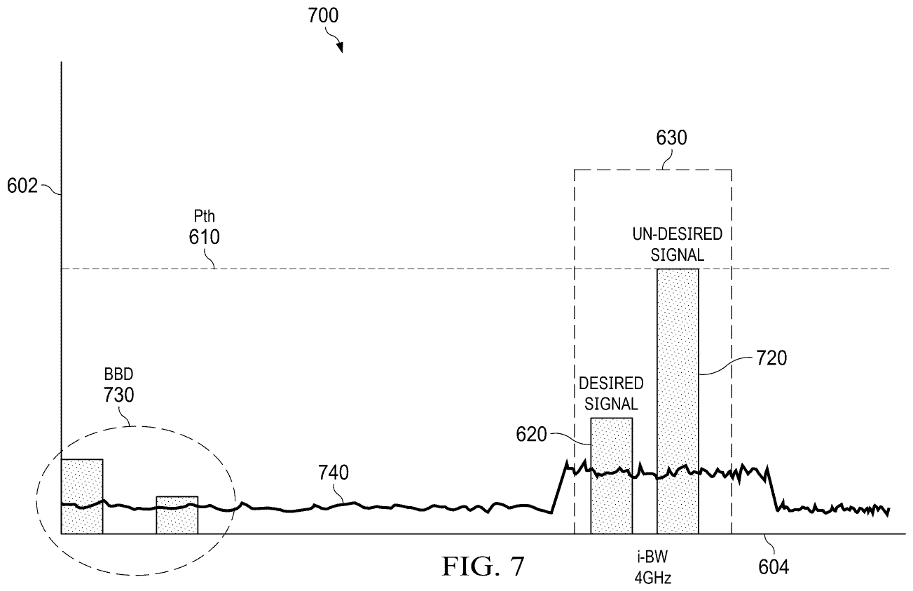

FIG. 7 is a graphical representation 700 of signal power 602 vs. frequency 604, in accordance with at least one embodiment of the present disclosure. In a second scenario, a desired signal 620 within a detection/filtering band 630 has a received power 602 that is less than the threshold power Pth 610. However, an undesired signal 720, occurring in the same detection/filtering band 630, is greater than Pth 610.

If the detected received power is >Pth, the SNDR of the LNA and receiver may be compromised in performance, and the bypass switch(es) and isolation switch would be configured for ISM operating mode (e.g., bypass switch(es) OFF) to eliminate high power level interference by identifying and notching/attenuating the high power interferer.

When the interfere is in-band, the ISM attenuates the entire band 630, where both the desired signal 620 and the undesired signal 720 reside. The ISM accomplishes this by ensuring that the total power is <~Pth at the output of the ISM detector. The ISM thus attenuates both the desired and undesired signal (losses of e.g. 1+1 dB for the switches and >20 dB for the ISM), the SNR will be degraded, but will still be high when compared to SNDR without the ISM.

The amplification of the attenuated signal by the LNA also produces in-band byproduct distortion 730 for lower frequencies, which can be detected by the distortion detector and thus, for some embodiments, used to switch the bypass switch(es) into the OFF (e.g., ISM enabled) state invoking the ISM path.

Line 740 shows noise plus distortion, which shows significant increase in distortion in the spectrum surrounding the large undesired signal. This is due inter-modulation effects in the LNA caused by the large undesired signal. Due to the close proximity of the desired signal to the undesired signal, the distortion also overlaps the desired signal.

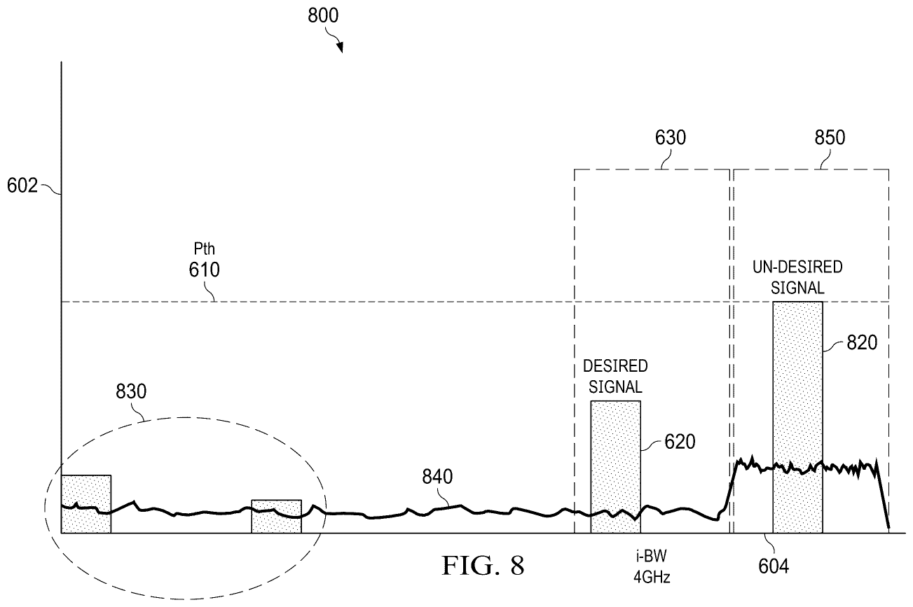

FIG. 8 is a graphical representation 800 of signal power 602 vs. frequency 604, in accordance with at least one embodiment of the present disclosure. In a third scenario, a desired signal 620 within a detection/filtering band 630 has a received power 602 that is less than the threshold power Pth 610. However, an undesired signal 820, occurring outside the detection/filtering band 630, is greater than Pth 610. Because there is a received signal with a power>Pth 610, and/or because distortion 830 is detected at low frequencies, the bypass switch(es) are placed or maintained in the OFF (e.g., ISM not bypassed) state.

When the interferer is outside of the band 630, the ISM attenuates the band 850 where the undesired signal 820 occurs, and thus does not degrade the in-band desired SNR. Thus, there are losses only for the switches (e.g., 1+1 dB), multiplexer (e.g., 1 dB) and ISM/FSL (e.g., 4 dB).

Line 840 shows noise plus distortion, which shows significant increase in distortion in the spectrum surrounding the large undesired signal. This is due inter-modulation effects in the LNA caused by the large undesired signal. Due to the close proximity of the desired signal to the un-desired signal, the distortion also overlaps the desired signal.

A full link analysis from antenna to ADC input was performed for various RF scenarios using state-of-the-art DC-40 GHz component block specifications that may be found in literature for a directly sampled RF RX system (no transceiver block). The cumulative RF performance was computed for 3 different cases when the RF input power=−30 dBm and an operating bandwidth is 4 GHz. State-of-the-art component functions were assumed for this analysis. The first case, a conventional RX architecture that does not utilize an ISM or bypass switch achieves the best NF ~5.3 dB, SNaDR of 68.5 dB and is NF limited. In the second case, using the embodiment 500 shown in FIG. 5, an ISM is inserted before the LNA, and the bypass and isolation switches are configured for ISM operation. In this case, the NF degrades to 12.3 dB and the SNR degrades to 54.5 dB. This corresponds to a degradation change of 7 dB in NF and 14 dB in SNR. The third case is where the bypass and isolation switches of embodiment 500 are now configured for RF bypass mode. The resulting NF is 6.3 dB and the SNR is 66.5 dB which is a 6 dB NF and a 12 dB SNR improvement over the second case for the ISM operating mode. This illustrates a significant improvement in sensitivity and SNR, enabled by the activation of the RF bypass path at lower power levels.

An analysis was also performed for three different cases when the RF input power=15 dBm and the operating bandwidth is 4 GHz. In this case a typical commercial off-the-shelf (COTS) receiver would be inoperable due over-compression of the receiver. However, since the analysis uses state-of-the-art component functions, in particular a high-linearity and dynamic range GaN LNA, the RX is still functional even at this high input power level. In this link analysis, the power coming out of the LNA will be higher than what would come out of a GaAs or silicon LNA, and thus a post LNA VGA/attenuator is set for each case so as not to over-drive the subsequent transceiver, differential driver and ADC. The attenuation is set so that the power at the differential driver output is 0 dBm, within its linear operation range.

In the first case, a conventional RX architecture that does not utilize an ISM or bypass switch achieves a NF of ~40.6 dB, SNaDR of 15.9 dB and is intermodulation distortion (IM3) limited as expected under high input power. The second case is embodiment 500, where an ISM is inserted before the LNA, and the bypass and isolation switches are configured for ISM operation. In this case, the NF degrades to 42.5 dB, but the SNR improves to 39.1 dB. This corresponds to a small degradation of ~2 dB in NF, but a significant improvement of ~23 dB in SNaDR, illustrating the value of the ISM under high input power levels. The third case is the embodiment 500 where bypass and isolation switches are configured for RF bypass mode. The resulting NF is 40.6 dB and the SNaDR degrades to 17.9 dB which is a ~2 dB NF and a ~21 dB SNaDR degradation, which is similar to the conventional case 1. Thus, the disclosed bypassable multiplexed ISM provides significant improvement in sensitivity, NF, and SNR under low input power conditions, while also providing high SNDR under high input power conditions (e.g., in the presence of an interferer).

A full link analysis from antenna to ADC input was also performed for various RF scenarios using state-of-the-art DC-40 GHz component block specifications that may be found in literature for a directly sampled RF RX system (no transceiver block), using design embodiment 500. This figure compares the cumulative RF performance for 3 different case when the RF input power=15 dBm and an operating BW of 40 GHz. In this case a typical COTS receiver would be inoperable due over-compression of the receiver. In the previous analysis we are using state-of-the-art component functions, in particular a high linearity and dynamic range GaN LNA which enabled the RX to still function even at this high input power level of 15 dBm. For the current analysis, and to compare the performance impact of using GaN vs GaAs LNA, this link analysis replaces the GaN LNA with a GaAs LNA. In this link analysis, a post LNA VGA/attenuator is set for each case so as not to over-drive the subsequent transceiver-section, differential driver and ADC. The attenuation is set so that the power at the differential driver output is 0 dBm, within its linear operation range. The first case a conventional RX architecture that does not utilize an ISM or bypass switch. This case 1 achieves a NF ~40.6 dB and a SNDR of only 10 dB which is IM3 limited. Although the NF is the same as the GaN case, the SNaDR is lower by ~6 dB than the GaN case. This is because the SNaDR is now IM3 distortion limited, and a high-dynamic-range GaN LNA provides better linearity than GaAs. The second case is embodiment 500 where an ISM is inserted before the LNA, and the bypass and isolation switches are configured for ISM operation. In this case the NF is 42.9 dB and the SNDR is 28.3 dB, limited by the ISM attenuation loss. This is a 0.4 dB NF and 0.8 dB SNDR degradation with respect to the GaN case and is limited by the ISM attenuation loss and impact on noise. The third case is the embodiment 500 where the bypass and isolation switches are now configured for RF bypass mode. The resulting NF is 40.6 dB and the SNDR is 8 dB which is IM3 limited. Although there is no degradation in NF, the SNDR is ~10 dB lower than the GaN case due to the poorer linearity of a GaAs pseudomorphic high electron mobility transistor (PHEMT) with respect to the GaN case. This is more evident in case 1 and 3, which indicates that the cascaded power levels have compressed the GaAs LNA and overall receiver. Thus, the use of GaN LNAs improves SNDR for all 3 RF scenarios vs the GaAs pHEMT under high input power, mainly due to the poorer device linearity and power characteristics of GaAs PHEMT, independent of the architecture mode of operation. Moreover, for either GaAs or GaN LNA implementations, the bypassable multiplexed ISM architecture configuration improves the NF, sensitivity, and low power SNR, as well as the high received input power SNDR through system choice of RF bypass or ISM operating modes (as defined above), combined with post LNA power leveling to the transceiver and data convert sections.

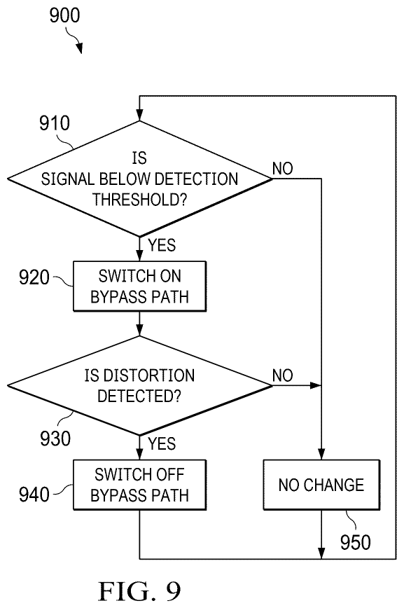

FIG. 9 is a schematic, diagrammatic representation, in flow diagram form of an example multiplexed ISM bypassing method 900, in accordance with at least one embodiment of the present disclosure. It is understood that the steps of method 900 may be performed in a different order than shown in FIG. 9, additional steps can be provided before, during, and after the steps, and/or some of the steps described can be replaced or eliminated in other embodiments. One or more of steps of the method 900 can be carried by one or more devices and/or systems described herein, such as components of the system 200, system 300, system 400, and/or system 500, or otherwise.

In step 910, the method 900 includes determining whether the input signal power (e.g., detected by the ISM) is below the threshold power Pth. If yes, execution proceeds to step 920. If no, execution proceeds to step 950.

In step 920, the method 900 includes switching on the RF bypass path to bypass the multiplexed ISM/FSL, connecting the antenna to the LNA through the bypass switch(es). Execution then proceeds to step 930.

In step 930, the method 900 includes determining whether the LNA distortion detector has detected distortion, which may be a sign that a high-power signal is passing through the LNA. If yes, execution proceeds to step 940. If no, execution proceeds to step 950.

In step 940, the method 900 includes switching off the bypass path, connecting the antenna to the LNA through the multiplexed ISM/FSL. Execution then proceeds to step 910.

In step 950, the method 900 includes making no change to the state of the bypass switch(es). Execution then proceeds to step 910.

Following is a step by step instruction on the RL algorithm flow framework for adapting to RF received spectrum.

### Algorithm Flow

1. RX initial conditions
a) Set LNA bias at a quiescent low noise bias.
b) Set bypass switches OFF to enable N-plexer+ISM RF path (no bypass).
c) Set ISM to all-pass response (NO notch FSL attenuation enabled).
2. ISM (input detector) detects whether Pin_ism>Pth (e.g., −20 dBm) at ISM input.
3. If Pin_ism>Pth (e.g., −20 dBm), then ISM will identify and enable attenuation in identified band(s) until Pout_ism<(Pth-abs(IL_ism)) through an RL algorithm agent that may use latency or low response time as a reward as described for example in U.S. Provisional Patent No. 63/660,385, filed 14 Jun. 2024, entitled “System and Methods for Controlling Filter Bank Device” and/or U.S. Pat. No. 11,245,427, filed 11 Feb. 2021, entitled “Frequency Selective Limiter”, both of which are incorporated by reference as though fully set forth herein.
4. Independently, the receiver LNA will receive the broadband RF spectrum, detect LNA baseband in-band byproduct distortion, and an RL agent will determine optimum LNA bias and ISM-FSL reward (performance) actions through an RL algorithm as described for example in U.S. Publication No. 2022/0255512, filed 29 Jul. 2020, entitled “Reconfigurable Amplifier” and/or U.S. Publication No. 2024/0048166, filed 17 Jul. 2023, entitled “Reinforcement Learning Receiver Front-End”, both of which are incorporated by reference as though fully set forth herein.
5. The two agents with separate tasks may operate independently, or may be managed to operate and be coordinated through a higher level supervisory agent. Subsequent power level control at the output of the LNA may be determined by the RL agent in response from received and detected (e.g., ISB-detected) spectral power information, and applied to a post LNA VGA/attenuator for optimizing the sensitivity and SNaDR of the full receiver system line up from the RF spectrum received from the antenna to the baseband and digital sections, as shown for example in FIGS. 3, 4, and 5.
6. Based on a higher system level supervisory agent of the system, the ISM setting may be reset to an all-pass response and the process outlined will start over again at step 1. This may be periodic, or random, and/or holistically determined by a higher order system.
7. When the ISM does not detect a Pin_ism>Pth (−20 dBm), then the RF bypass switches will enable a bypass RF path for reducing loss (e.g., by 5-6 dB) and improve NF, sensitivity, SNR, and dynamic range of the receiver system as described above. In this operating state, the ISM may be reset to either all-pass response or all-attenuation response, the former may be desirable to reduce latency when high LNA baseband byproduct distortion (BBD) is detected. If high distortion is detected from the LNA baseband byproduct distortion (BBD) detector or dynamic operating bias, or any other spectral sense detector in the higher level system that infers SNaDR is significantly compromised, the bypass switches will switch to the ISM RF path in which case the initial conditions in step 1 will be fully or partially reset and the ISM operation (selective spectral detection and attenuation) are invoked again.
8. Note: IF only one bypass switch is used, the bypass RF path would be enabled and the ISM-FSL can be set to an ALL no-pass condition to minimize ISM loading effects on the LNA input. In order to further minimize this ISM loading effect, an additional isolation switch at the output of the ISM can be configured open or decoupled from the LNA input during ISM bypass mode. This is complementary to (e.g., in addition to) the bypass switch being enabled.

Flow diagrams are provided herein for exemplary purposes; a person of ordinary skill in the art will recognize myriad variations that nonetheless fall within the scope of the present disclosure. Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time as described herein.

The scope of the present disclosure applies to RL assisted front-end receiver systems and architectures, and includes the following features:
1. The use of a bypass switch in conjunction with a receiver that incorporates broadband ISM (FSL) in front of an LNA to improve the overall receiver NF and sensitivity (e.g., by 4-5 dB) and SNR (SNDR) (e.g., by 8-10).
2. A first RF bypass switch coupled to antenna and LNA input
3. An optional second RF bypass switch coupled to ISM output (see FIGS. 4 and 5) and LNA input, for providing isolation and reduced LNA input loading when the system is in ISM-bypass mode.
4. A reinforcement learning (RL) model that optimizes receiver sensitivity, SNDR, and DC efficiency by 1) actuating the bypass and isolation switches, 2) changing LNA bias and 3) configuring the ISM attenuation states in response to detected system parameters inclusive of a) RF input power and/or spectrum at ISM input, RF output power and/or spectrum at ISM output, changes in RL-LNA gate(s) and drain current, previous RL-LNA bias-reward states, previous ISM reward states, baseband detected signal, and any lookup table (LUT) and/or model (whether static or dynamic) retrieved from past experience to be exploited for reducing latency and improving efficiency of the RL model.
5. The use of the LNA baseband byproduct distortion (BBD) detection level as an indicator to switch from high sensitivity bypass mode (Pin_ism<Pth) to ISM operating mode (Pin_ism>Pth AND Pout_ism>Pth+abs(ISM loss)), and more particularly, when the LNA is in a high linearity bias (voltage at drain (Vdd) and current at drain (Idd)) greater than initial quiescent low noise bias state.
6. The use of the ISM input power detector (Pin_ism) level as an indicator to switch from ISM operating mode to high sensitivity bypass mode, more specifically, when Pin_ism<Pth.
7. The use of the ISM output power detector (Pout_ism) level an indicator for setting individual FSL attenuator bands to reduce detected Pout_ism<Pth-abs (ISM loss).

### Preferred Embodiment Features

In one embodiment, RF bypass switches are actuated to bypass the ISM path when received power is below a given power threshold Pth that is detected by the ISM (or other external detector in the overall system), resulting in a reduction of loss (from −5 to −2 dB) to improve NF and sensitivity (e.g., by as much as 4-5 dB and SNR by 8-10 dB). Above a given detected power level Pth (e.g., ~−20 dBm), the RF bypass switches may be actuated to employ the ISM, which improves the SNDR in the presence of a larger received RF power spectrum.

In another embodiment, an additional 1 dB of sensitivity and 2 dB of SNR improvement may be obtained by employing only one bypass switch in the RF path between the antenna and the LNA input.

An isolation switch may be coupled directly to the ISM output to improve the isolation between the LNA input and the disabled ISM in bypass mode in order to reduce input loading effect on the LNA and RF bypass path when RF bypass is enabled.

Detected received power level may for example be obtained from the ISM input power and output power detectors, or any external detector, and may be operated autonomously or using machine learning or reinforcement learning (ML/RL) assistance.

The use of the LNA baseband in-band byproduct distortion level is one possible indicator to decide when to configure the bypass and isolation switches to enable the ISM RF path and invoke ISM operation under larger RF power levels.

Changes in LNA dynamic bias (e.g., changes generated by the RL model) may be another indicator to decide when to configure the bypass and isolation switches to enable the ISM RF path and invoke ISM operation.

Depending on the implementation, the post LNA VGA/attenuator function may be a digital or an analog controlled IC implemented with silicon on insulator (SOI) technology.

The post-LNA VGA/Attenuator function may be implemented for broadband operation and autonomously controlled like an automatic gain control (AGC), or may be deliberately controlled by the ML/RL agent.

The post LNA VGA/attenuator function may be implemented by a broadband N-plexed ISM for selectively leveling down large RF signals in specific frequency bands while allowing unattenuated signals in a desired band to pass in conjunction with the overall system operation for optimizing overall system performance.

As will be readily appreciated by those having ordinary skill in the art after becoming familiar with the teachings herein, the bypassable multiplexed ISM advantageously provides a mechanism for bypassing a multiplexed ISM during times of low input signal power, and for enabling the multiplexed ISM during times of high input signal power, so as to minimize signal loss, while maximizing sensitivity and SNDR. Accordingly, it can be seen that the bypassable multiplexed ISM fills a need in the art, by allowing the advantages of a reinforcement learning receiver with and without a pre-LNA multiplexed ISM/FSL to coexist in a single receiver.

A number of variations are possible on the examples and embodiments described above. For example, the N-plexer may include any number of ISMs or signal bands, from a single band to several dozen bands. An ISM may include any number of FSLs, from one FSL to several dozen FSLs. The bypass and/or isolation switches may be of any type, whether mechanical or solid-state. The LNA may be implemented in GaN, GaAs, silicon, or any other appropriate material, and may have a bandwidth anywhere between DC and 45 GHz. The variable gain amplifier/attenuator may be self-regulated (as with an automatic gain control), or may be controlled by the reinforcement learning agent, and may optionally be implemented as an ISM and/or FSL. The switch driver may receive inputs from any or all of the ISM input power detector, the ISM output power detector, an external power detector, the LNA distortion detector, and/or the reinforcement learning agent. The reinforcement learning agent may include, as outputs, any or all of a bias and/or supply voltage, one or more FSL switch settings, and/or a level control for the variable gain amplifier/attenuator. The reinforcement learning agent may be implemented in any combination of hardware, software, firmware, field programmable gates, or field programmable neurons.

The technology described herein may be applied to receivers for satellite communication, terrestrial communication or radar, and may find particular utility in environments where weak desired signals coexist with stronger undesired signals, whether in the same or in different bands.

The logical operations making up the embodiments of the technology described herein are referred to variously as operations, steps, blocks, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the bypassable multiplexed ISM. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the bypassable multiplexed ISM as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A radio frequency (RF) receiver, comprising:
a signal path comprising:
an antenna;
a low noise amplifier (LNA) operatively coupled to the antenna; and
a variable gain amplifier/attenuator operatively coupled to the LNA;
an intrinsically switched multiplexer (ISM);
a bypass switch network operatively coupled to the ISM and selectively operable between a first state and a second state, wherein in the first state the ISM is switched into the signal path between the antenna and the LNA, and wherein in the second state the ISM is bypassed out of the signal path; and
a switch driver configured to set the bypass switch network into the first state based on a first detection and to set the bypass switch network into the second state based on a second detection.

2. The RF receiver of claim 1, wherein the bypass switch network comprises a first RF bypass switch that, in the second state, couples the antenna to the LNA and, in the first state, couples the antenna to the ISM.

3. The RF receiver of claim 2, wherein the bypass switch network further comprises a second RF bypass switch that, in the second state, uncouples the ISM from the LNA and, in the first state, couples the ISM to the LNA.

4. The RF receiver of claim 1, wherein the second detection comprises a power level at an input of the ISM or a power level at an output of the ISM.

5. The RF receiver of claim 1, further comprising a distortion detector configured to detect baseband distortion byproducts from the LNA, wherein the first detection comprises a distortion level detected by the distortion detector.

6. The RF receiver of claim 5, further comprising a reinforcement learning model or lookup table that receives inputs from the distortion detector and a power detector or power spectrum detector of the ISM, and generates outputs to perform at least one of:
actuating the bypass switch network;
changing a bias of the LNA;
changing an amplification or attenuation of the variable gain amplifier/attenuator; or
configuring attenuation states of the ISM.

7. The RF receiver of claim 6, wherein the first detection or the second detection comprises a change in the bias of the LNA generated by the reinforcement learning model or lookup table.

8. A method for using an RF receiver, the RF receiver comprising:
a signal path comprising:
an antenna;
a low noise amplifier (LNA) operatively coupled to the antenna; and
a variable gain amplifier/attenuator operatively coupled to the LNA;
an intrinsically switched multiplexer (ISM);
a bypass switch network operatively coupled to the ISM and selectively operable between a first state and a second state, wherein in the first state the ISM is switched into the signal path between the antenna and the LNA, and wherein in the second state the ISM is bypassed out of the signal path; and
a switch driver configured to select between the first state and the second state, wherein the method comprises:
with the switch driver:
setting the bypass switch network into the first state based on a first detection; and
setting the bypass switch network into the second state based on a second detection.

9. The method of claim 8, wherein the bypass switch network comprises a first RF bypass switch that, in the second state, couples the antenna to the LNA and, in the first state, couples the antenna to the ISM.

10. The method of claim 9, wherein the bypass switch network further comprises second RF bypass switch that, in the second state, uncouples the ISM from the LNA and, in the first state, couples the ISM to the LNA.

11. The method of claim 8, wherein the second detection comprises a power level at an input of the ISM or a power level at an output of the ISM.

12. The method of claim 8, further comprising detecting baseband distortion byproducts from the LNA with a distortion detector, wherein the first detection comprises a distortion level detected by the distortion detector.

13. The method of claim 12, further comprising, with a reinforcement learning model or lookup table:
receiving inputs from the distortion detector and a power detector or power spectrum detector of the ISM; and
generating outputs to perform at least one of:
actuating the bypass switch network;
changing a bias of the LNA;
changing an amplification or attenuation of the variable gain amplifier/attenuator; or
configuring attenuation states of the ISM.

14. The method of claim 13, wherein the first detection or the second detection comprises a change in the bias of the LNA generated by the reinforcement learning model or lookup table.

15. A wireless device comprising:
an RF receiver comprising:
a signal path comprising:
an antenna;
a low noise amplifier (LNA) operatively coupled to the antenna; and
a variable gain amplifier/attenuator operatively coupled to the LNA;
an intrinsically switched multiplexer (ISM);
a bypass switch network operatively coupled to the ISM and selectively operable between a first state and a second state, wherein in the first state the ISM is switched into the signal path between the antenna and the LNA, and wherein in the second state the ISM is bypassed out of the signal path; and
a switch driver configured to set the bypass switch network into the first state based on a first detection and to set the bypass switch network into the second state based on a second detection.

16. The wireless device of claim 15, wherein the bypass switch network comprises a first RF bypass switch that, in the second state, couples the antenna to the LNA and, in the first state, couples the antenna to the ISM.

17. The wireless device of claim 16, wherein the bypass switch network further comprises second RF bypass switch that, in the second state, uncouples the ISM from the LNA and, in the first state, couples the ISM to the LNA.

18. The wireless device of claim 15, wherein the second detection comprises a power level at an input of the ISM or a power level at an output of the ISM.

19. The wireless device of claim 15, further comprising a distortion detector configured to detect baseband distortion byproducts from the LNA, wherein the first detection comprises a distortion level detected by the distortion detector.

20. The wireless device of claim 19, further comprising a reinforcement learning model or lookup table that receives inputs from the distortion detector and a power detector or power spectrum detector of the ISM, and generates outputs to perform at least one of:
actuating the bypass switch network;
changing a bias of the LNA;
changing an amplification or attenuation of the variable gain amplifier/attenuator; or
configuring attenuation states of the ISM.
